(19) United States
(12) Patent Application Publication
(10) Pub. No.: US 2008/0196708 A1
(43) Pub. Date: Aug. 21, 2008

(54) Object For Guiding and Reflecting Heat and Grill-Roaster

(76) Inventor: Sang Moo Lee, Gyenggi-do (KR)

Correspondence Address: AKC PATENTS, 215 GROVE ST., NEWTON, MA, 02466, US

(21) Appl. No.: 11/912,513

(22) PCT Filed: Apr. 28, 2006
(86) PCT No.: PCT/KR2006/001595

§ 371 Date: Oct. 25, 2007

(30) Foreign Application Priority Data
Apr. 29, 2005 (KR) 20-2005-0012128

(51) Int. Cl. A47J 37/00

(52) U.S. Cl. 126/25 R

(57) ABSTRACT

A thermal diffusion apparatus as an object for guiding and reflecting heat, which is provided between grill and heat source and is configured so as to diffuse the heat supplied directly upwards from the heat source for uniform dispersion thereof, is disclosed. The disclosed thermal diffusion apparatus includes a heat inducing diffuser for diffusing the heat supplied directly upwards from the heat source to induce it in a 360 degree radial direction of the grill; and a support for supporting the heat inducing diffuser so as to place said heat inducing diffuser between heat source and grill.

### TECHNICAL FIELD

The present invention relates to an object for guiding and reflecting heat and grill-roaster having the same, and more specifically to an object for guiding and reflecting heat which is placed between a grill and a heat source so as to induce and diffuse the heat supplied directly upwards from the heat source in the 360 degree radial direction of the grill and a grill-roaster having the same.

### BACKGROUND ART

In the conventional grill-roaster, heat generated from a heat source such as charcoal fire, gas fire, briquette fire or electrical heat is supplied directly to the grill without being intercepted midway. This has a problem that because the heat of the heat source is applied intensively to the center of the grill, the meat put on the center of the grill is likely to be burned while the meat put on the edge of the grill is not cooked well because of slow heat transfer.

Moreover, because the heat generated from the heat source is applied to the center of the grill without diffusion, the grill is heated rapidly to high temperatures whereby causing the meat to stick to and burn on the grill, so not only does it make it difficult to eat but also a large amount of harmful substances are generated from the meat which are damaging to people's health. In addition, because of the smoke generated in the process of the meat being stuck to and burned on the grill or the smoke generated due to meat fat or spices dropping onto the heat source from the center of the grill, there is another problem of turbidity inside the room. Because of this, smoke is discharged outside by updraft or downdraft ducts, but this also causes environmental pollution.

### DISCLOSURE OF INVENTION

### Technical Problem

To solve such problems, it is an object of the present invention to provide an object for guiding and reflecting heat for causing the meat placed on the edge of the grill to cook slowly without burning by diffusing the heat supplied to the center of the grill in the 360 degree radial direction of the grill.

Another object of the present invention is to provide an object for guiding and reflecting heat which is not only sanitary since meat does not stick to the grill, but which can also prevent smoke from being generated due to the above described problems.

Yet another object of the present invention is to provide a grill-roaster having a thermal diffusion apparatus which can prevent generation of smoke by causing meat fat or spices put on the edge of the grill to drop into a drip pan instead of the heat source.

### Technical Solution

To achieve the above objects, there is provided an object for guiding and reflecting heat comprising: a heat inducing diffuser for diffusing the heat supplied directly upwards from a heat source to induce it in a 360 degree radial direction of a grill; and a support for supporting said heat inducing diffuser so as to place said heat inducing diffuser between the heat source and the grill.

In accordance with another aspect of the present invention, there is provided a grill-roaster comprising: a heat source; an oil sump in which a drip pan portion is formed at the bottom end and a stepped portion is formed at the top and the center is open for said heat source to be inserted therein; a grill supported by said stepped portion of said oil sump; a heat inducing diffuser for diffusing the heat supplied directly upwards from said heat source to induce it in the 360 degree radial direction of the grill; and a support for supporting said heat inducing diffuser so as to place it between the heat source and the grill.

### ADVANTAGEOUS EFFECTS

The object for guiding and reflecting heat according to the present invention diffuses the heat supplied to the center of the grill in the 360 degree radial direction of the grill so that the meat placed on the edge of the grill is cooked slowly without burning, and is not only sanitary as meat does not stick to the grill but can also prevent smoke from being generated due to this. Moreover, a roaster according to the present invention causes the meat fat or spices placed on the edge of the grill to drop into a drip pan instead of the heat source so that smoke generation due to this can be prevented.

### BRIEF DESCRIPTION OF THE DRAWINGS

These and other features, aspects, and advantages of preferred embodiments of the present invention will be more fully described in the following detailed description, taken accompanying drawings. In the drawings:

FIGS. 1 through 4 are perspective views illustrating modifiable various shapes of the heat inducing diffuser according to the present invention;

FIG. 5 and FIG. 6 are perspective views showing other modifications of the heat inducing diffuser according to the present invention;

FIG. 7 is a schematic view showing another preferred modification of the heat inducing diffuser according to the present invention;

FIGS. 8 through 11 are views illustrating modifiable various shapes of a support supporting the heat inducing diffuser according to the present invention;

FIG. 12 is a sectional view of a roaster according to the present invention; and

FIG. 13 is a sectional view of another modification of the roaster according to the present invention.

### BEST MODE FOR CARRYING OUT THE INVENTION

As an object for guiding and reflecting heat according to the present invention, a thermal diffusion apparatus including a heat inducing diffuser 10 is disclosed. The material of the heat inducing diffuser is not especially limited, but material such as stainless steel, brass or ceramic, which has a good heat resistance and hardness, and is not deformed even if it is used repeatedly at extremely high temperatures, is preferable.

The heat inducing diffuser 10 is placed between a heat source and a grill through a support so as to diffuse the heat supplied directly upwards from the heat source and to induce it in the 360 degree radial direction of the grill, so that heat is diffused to the edge of the grill. Accordingly, the 360 degree edge excluding the center portion of the grill is heated uniformly by the heat inducing diffuser 10, and heat is diffused, so meat can be roasted by moderate heat. Therefore, when the user roasts meat on the edge of the grill, the meat placed on the edge is not burnt or stuck thereto, and the inside of the meat is gradually roasted by the far-infrared radiation of the heat source so as to make the meat taste better. Furthermore, since the meat does not stick to the grill, it is not only sanitary but also it is possible to prevent smoke from being generated due to this.

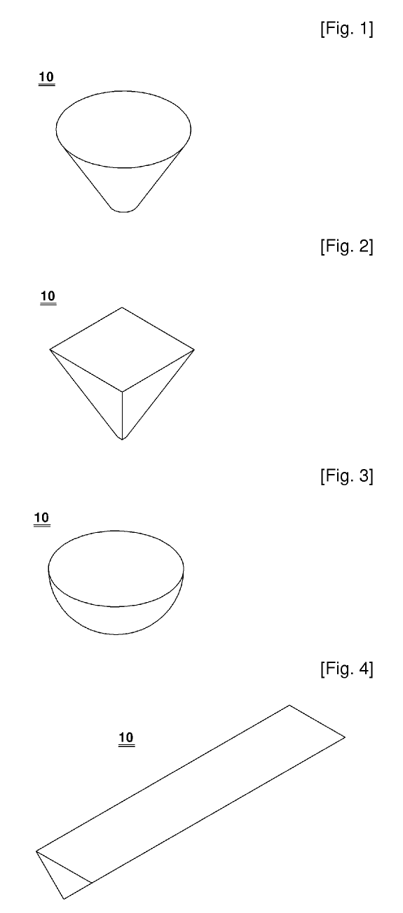

It is preferable to make the heat inducing diffuser 10 according to the present invention in a top-wide and bottom-narrow shape. More specifically, it can be made in a conical shape as shown in FIG. 1, in a square pyramid shape as shown in FIG. 2, in a hemispherical shape as shown in FIG. 3, or in a triangular pyramid shape having triangular sections as shown in FIG. 4. And, though not shown, it will be obvious to those skilled in the art that it can be made in many other various pyramid shapes. Here, the triangular pyramid shape having triangular sections as shown in FIG. 4 can be conveniently used in a grill of a long rectangular shape. If a heat inducing diffuser having the top-wide and bottom-narrow shape is placed between the heat source and the grill, the heat supplied directly upwards from the heat source is diffused along the slope of the heat inducing diffuser 10 before it is induced to the edge of the grill located above it so as to be uniformly dispersed. Meanwhile, the top side of the heat inducing diffuser 10 may be either open or sealed.

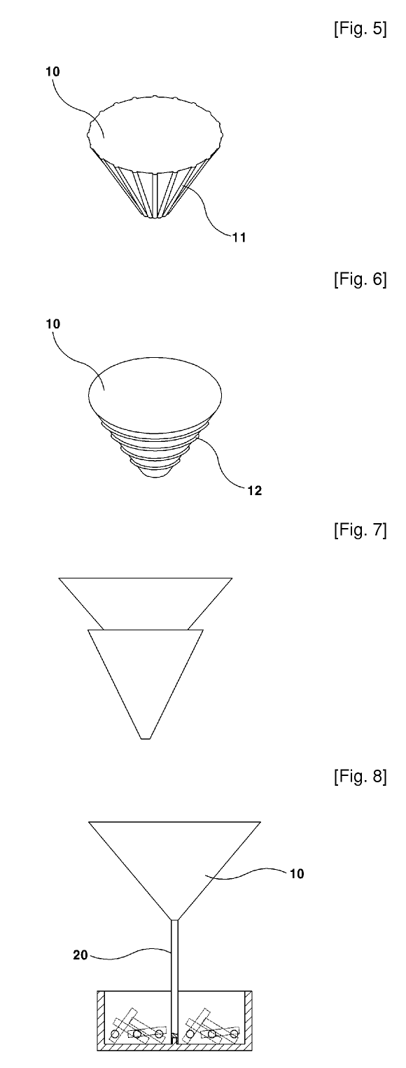

In FIG. 5 and FIG. 6 are shown examples of modification of the heat inducing diffuser 10 according to the present invention. Referring to the drawings, on the outer surface of a heat inducing diffuser of a top-wide and bottom-narrow shape are formed a plurality of heat inducing protuberances 11 and 12 in the radial direction (See FIG. 5) or circumferential direction (See FIG. 6). Heat inducing protuberances 11 and 12 play the role of adjusting the heat and the wavelength of radiant heat reaching the grill by inducing scattered reflection when the heat from the heat source is diffused in the radial direction from the slope of the heat inducing diffuser 10.

FIG. 7 shows another modification of the heat inducing diffuser according to the present invention. As shown in the drawing, the top-wide and bottom-narrow heat inducing diffuser can be configured by multistage stacking. Since a multistage stacking structure heats the grill by doubly providing the diffusion angle of the induced heat, the thermal diffusion efficiency can be increased.

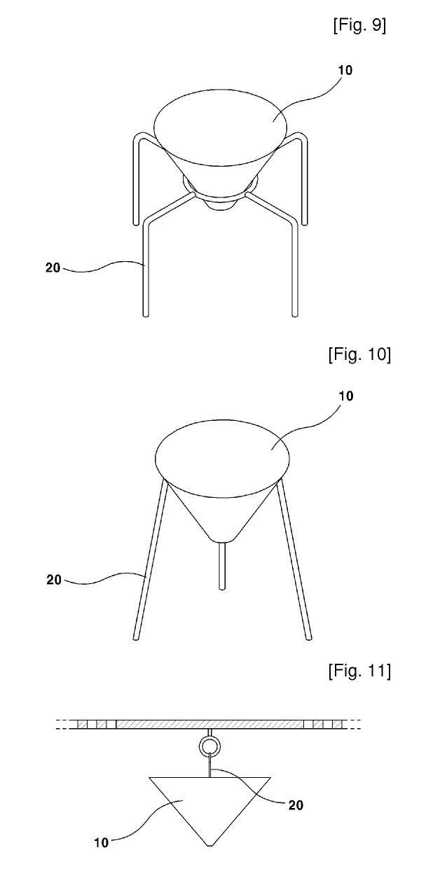

The configuration of the support 20 used for placing the heat inducing diffuser 10 between the heat source and the grill is not especially limited. For instance, it may be in a shape of a support rod 20 mounted or fixed on the heat source as shown in FIG. 8, a support leg 20 of various shapes as shown in FIG. 9 or FIG. 10, or a ring 20 hooked on the grill as shown in FIG. 11. Also, it will be obvious to those skilled in the art that it can have many other various shapes not shown.

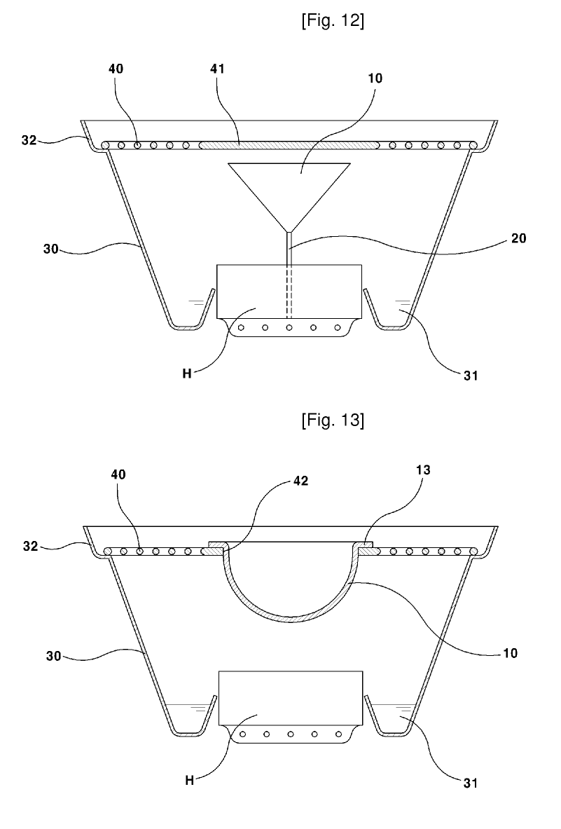

Below will be described a grill-roaster of the present invention having the above-mentioned thermal diffusion apparatus. FIG. 12 is a sectional view of a grill-roaster according to the present invention. Referring to the drawing, it is characterized by comprising a heat source H; an oil sump 30 in which a drip pan portion 31 is formed at the bottom end and a stepped portion 32 is formed at the top and the center is open for the heat source H to be inserted therein; a heat inducing diffuser 10 which diffuses the heat supplied directly upwards from the heat source to induce the heat in a 360 degree radial direction of the grill 40; and a support 20 which supports the heat inducing diffuser 10 to be placed between the heat source H and the grill 40.

For the heat source H, various heat generating sources such as charcoal fire, gas fire, briquette fire or electric heat may be used. Of these, especially charcoal fire roasts meat with radiant heat, making meat taste better, so it may be used preferably in the present invention.

In the oil sump 30, the bottom end is bent to form the drip pan portion 31 and a stepped portion 32 is formed at the top. The drip pan portion 31 contains water to prevent smoke from being generated by causing oil or spices to drop into the water. And, the stepped portion 32 plays the role of supporting the grill 40. Also, the center of the oil sump 30 is open for the heat source to be inserted therein.

To use the grill-roaster of such a configuration, first put a heat source H into the opening of the oil sump 30 and put the grill 40 on the stepped portion 32. Also place a heat inducing diffuser 10 between the heat source H and the grill 40 by using a support 20 of various shapes as mentioned above.

Since a roaster of such a configuration according to the present invention has a thermal diffusion apparatus, the heat supplied directly upwards from the heat source H is diffused in the radial direction of the grill 40 so as to be uniformly induced. Accordingly, when the user puts meat to be roasted on the edge of the grill, the meat placed on the edge won't be burnt or stuck, and the meat is roasted gradually to the inside by the far-infrared radiation of the heat source, making the meat taste better, and as the meat does not stick to the grill, it is sanitary. Moreover, since meat fat or spices placed on the edge of the grill drop into the water of the drip pan portion 31 of the oil sump, smoke is not generated so that the room is prevented from becoming turbid. Furthermore, as shown in the drawing, the center portion 41 of the grill is made in a sealed form so as to make it possible to move the meat to the center portion 41 and eat the meat cooked on the edge slowly. At this time, to prevent meat fat or spices from dropping into the heat source, it is preferable to make the width of the center portion 41 of the grill greater than that of the heat source.

Meanwhile, FIG. 13 shows an example of modification of the roaster according to another embodiment of the present invention. This is configured in such a way that the heat inducing diffuser 10 can play a role of a soup bowl as well. More specifically, a support portion 42 is formed on the center of the grill, and the edge of a top-wide bottom-narrow heat inducing diffuser 10 is bent to form an extension portion 13. When in use, the heat inducing diffuser 10 is inserted into the support portion 42, and then the extension portion 13 is held by the support portion 42. So the heat inducing diffuser 10 has an advantage in addition to above-mentioned basic function in that it is possible to put soup in the space inside the heat inducing diffuser to boil and eat it.

Although the present invention has been described in connection with the exemplary embodiments illustrated in the drawings, it is only illustrative. It will be understood by those skilled in the art that various modifications and equivalents can be made to the present invention. Therefore, the true technical scope of the present invention should be defined by the appended claims.

1. An object for guiding and reflecting heat comprising:
a heat inducing diffuser for diffusing the heat supplied directly upwards from a heat source to induce it in a 360 degree radial direction of a grill; and
a support for supporting said heat inducing diffuser so as to place said heat inducing diffuser between the heat source and the grill.

2. The object of claim 1 wherein said heat inducing diffuser has a top-wide bottom-narrow shape such as a cone, hemisphere, square pyramid and triangular pyramid.

3. The object of claim 2 wherein heat inducing protuberances extended along the radial direction or circumferential direction are formed on the outer surface of said heat inducing diffuser.

4. The object of claim 2 wherein said heat inducing diffusers are stacked multistage.

5. A grill-roaster comprising:
a heat source;
an oil sump in which a drip pan portion is formed at the bottom end and a stepped portion is formed at the top and the center is open for said heat source to be inserted therein;
a grill supported by said stepped portion of said oil sump;
a heat inducing diffuser for diffusing the heat supplied directly upwards from said heat source to induce it in the 360 degree radial direction of the grill; and
a support for supporting said heat inducing diffuser so as to place it between the heat source and the grill.

6. The grill-roaster of claim 5 wherein the center portion of said grill is formed so as to be closed but the width of the center portion is greater than that of the heat source.

7. The grill-roaster of claim 5 is characterized by that a support portion is formed on the center of said grill and an extension portion is bent-formed on the side of the top end of a top-wide bottom-narrow heat inducing diffuser so that the heat inducing diffuser can be used as a soup bowl by mounting the extension portion on the grill after inserting said heat inducing diffuser into the support portion.
